(19) United States
(12) Patent Application Publication
(10) Pub. No.: US 2021/0277208 A1
(43) Pub. Date: Sep. 9, 2021

(54) TREAD OF TBR PNEUMATIC TIRES OF DRIVING WHEELS

(71) Applicant: BRIDGESTONE EUROPE NV/SA, Zaventem (BE)

(72) Inventors: Gianluca Forte, Roma (IT); Alessio Cavaliere, Roma (IT)

(21) Appl. No.: 17/257,910

(22) PCT Filed: Jul. 2, 2019
(86) PCT No.: PCT/IB2019/055636

§ 371 Date: Jan. 5, 2021

(30) Foreign Application Priority Data
Jul. 9, 2018 (IT) 102018000007028

(51) Int. Cl. C08L 7/00; C08L 9/06; B60C 1/00; B60C 11/03

(52) U.S. Cl. CPC C08L 7/00; C08L 9/06; B60C 2200/06; B60C 11/0306; B60C 1/0016

(57) ABSTRACT

A TBR pneumatic tire of a driving wheel comprising a tread having a design such as to confer an average tread slip of less than 0.5 mm and a tread points slip range of between 0.07 mm and 1.17 mm. The tread is manufactured with a compound comprising a cross-linking unsaturated chain polymer base comprising from 40 to 80% by weight of a stirene-butadiene rubber (SBR), a filler comprising from 40 to 80% by weight of silica and a vulcanization system.

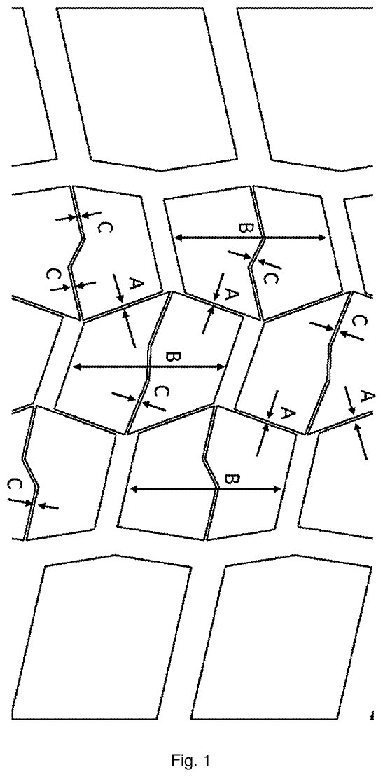

The present invention relates to a tread of TBR pneumatic tires of driving wheels.

The abbreviation “TBR” is an acronym of the English wording “Truck & Bus Radial tire”.

As is to be immediately expected, for TBR pneumatic tires a significantly higher level of wear resistance is necessarily required compared to pneumatic tires for passengers. Indeed, TBR pneumatic tires must be prepared for being subjected both to very high loads and to traveling over rough roads.

For some time now, also in the field of TBR pneumatic tires, part of the research is aimed at improving the performance thereof in terms of rolling resistance.

As is known to persons skilled in the art, a solution for improving the rolling resistance of a pneumatic tire tread is in relation to an increase in the amount of silica within the relative rubber compound.

However, an increase in the amount of silica as a substitute for the carbon black within the compound necessarily results in a decrease in the wear resistance and in the resistance to the propagation of cracks within the tread, with negative consequences concerning the service life of the pneumatic tire.

Obviously, for TBR pneumatic tires a deterioration cannot possibly be accepted in terms of wear resistance and crack propagation by virtue of an improvement in terms of rolling resistance.

Furthermore, the aforementioned disadvantages in terms of wear resistance and the propagation of cracks are more evident wherein they concern the pneumatic tires of driving wheels.

The driving wheels are the wheels of a means of locomotion whereto the force is transferred that is released by the engine in the form of torque by means of the propeller shaft and the differential. The driving wheels are, therefore, connected to the engine and allow the vehicle to move as a result of the frictional forces exchanged between the wheels and the road. As may seem immediate to a person skilled in the art, insofar as they are subject to high torque and at a high slip ratio, driving wheels have a wear dynamic that is different than the wheels of the trailer.

The need was therefore felt to have a solution for the tread of the TBR pneumatic tires of driving wheels that would make it possible to ensure an improvement in terms of rolling resistance, without thereby worsening the wear resistance and/or compromising the duration of the life of the pneumatic tire as a whole.

The inventors of the present invention have surprisingly found that if a tread has the combination of a design with particular slip requirements along with a particular composition of the compound of origin, it is possible to obtain an improvement in terms of rolling resistance without incurring a deterioration in terms of wear resistance and the durability of the pneumatic tire.

The object of the present invention is a TBR pneumatic tire of a driving wheel comprising a tread having a design such as to give an average tread slip of less than 0.5 mm and a slip range for the tread points of between 0.07 mm and 1.17 mm; these slip parameters being measured under the condition of a rolling speed of 0.012 Km/h, of a vertical load equal to the nominal load of the pneumatic tire, of torque in Nm equal to half of the nominal load of the pneumatic tire, of lateral slip angles and camber angles equal to zero; said pneumatic tire being characterized in that said tread is manufactured with a compound comprising a cross-linking unsaturated chain polymer base comprising from 40 to 80% by weight of a stirene-butadiene rubber (SBR), a filler comprising from 40 to 80% by weight of silica and a vulcanization system.

Here and hereinafter with the term “tread” it is intended the set comprising the “cap” portion and the “base” portion of the tread. In fact, many pneumatic tires have a tread composed of the combination of the aforementioned portions, wherein the respective compounds thereof differ from one another and wherein the relative thickness thereof varies depending upon the type of pneumatic tire concerned. In this way, it is understood that the present invention can be applied either only to the compound in relation to the cap portion or to both of the compounds respectively in relation to the cap portion and the base portion.

Here and hereinafter, the term “cross-linkable unsaturated-chain polymer base” refers to any natural or synthetic non-cross-linked polymer capable of assuming all of the chemical-physical and mechanical characteristics typically assumed by elastomers after cross-linking (vulcanization) with sulfur-based systems.

Here and hereinafter, vulcanization system refers to a complex of ingredients comprising at least sulfur and accelerating compounds, that in the preparation of the compound are added in a final mixing step and have the purpose of promoting the vulcanization of the polymer base once the compound is subjected to a vulcanization temperature.

Preferably, the cross-linking unsaturated chain polymer base comprises from 50 to 70% by weight of a stirene-butadiene rubber (SBR).

Preferably, the filler comprises from 50 to 70% by weight of silica and a vulcanization system.

Preferably, the polymer base comprises natural rubber.

Preferably, the filler comprises carbon black.

The following are purely illustrative and non-limiting exemplary embodiments shown with the help of the annexed figure, which illustrates a tread portion.

### EXAMPLES

Four pneumatic tires were manufactured, each of which has a different combination of tread design and composition of the tread compound itself.

In particular, three comparison pneumatic tires (A-C) and a pneumatic tire according to the invention (D) were manufactured. The comparison tire A has the combination of a design with slip characteristics that are greater than those provided for by the present invention and a compound composition that is different than that according to the present invention and typical of a tread compound for TBR pneumatic tires; the comparison pneumatic tire B has the combination of a design with slip characteristics that are greater than those provided for by the present invention and a compound composition according to the present invention; the comparison pneumatic tire C has the combination of a design with slip characteristics according to the present invention and a compound composition that is different than that according to the present invention and typical of a tread compound for TBR tires. The pneumatic tire according to the invention D has, in comparison, the combination of a design with slip characteristics according to the present invention and a compound composition according to the present invention.

The pneumatic tires C and D have a tread pattern as illustrated in the annexed figure. In particular the design of the pneumatic tires C and D provides that the distance A is 1.5 mm; the distance B is 70.0 mm; the distance C is 0.55 mm.

The tread pattern shown in the figure confers a slip value according to that stated within the accompanying independent claim in the event wherein: the distance A is between 1.0 and 2.0 mm; the distance B is between 60.0 and 80.0 mm; the distance C is between 0.40 and 0.70 mm.

As mentioned above, the drawing shown in the figure has an illustrative and non-limiting scope, and the pneumatic tire of the present invention can also be manufactured with a different tread pattern from the one illustrated, provided that it confers a slip value that is within the parameters stated within the accompanying independent claim.

Herebelow, the procedure is given for the preparation of the compounds described in the examples. This procedure does not represent a limitation for the present invention.

—Preparation of the Compounds—

(1^{st} Mixing Step)

Before the start of the mixing, a mixer with tangential rotors and an internal volume of between 230 and 270 liters was loaded with the ingredients listed in Table I to the exclusion of the vulcanization agents and the zinc oxide, reaching a fill factor of between 66-72%.

The mixer was operated at a speed of 40-100 revolutions/minute, and the mixture thus formed was discharged once a temperature of 140-170° C. had been reached.

(2^{nd} Mixing Step)

The mixture thus obtained was processed once again in a mixer operated at a speed of between 40-60 revolutions/minute. Subsequently, once the compound reaches a temperature of between 130-150° C. it is discharged.

(Final Mixing Step)

The vulcanization agents and zinc oxide were added to the mixture obtained from the previous step, reaching a fill factor of between 63-67%.

The mixer was operated at a speed of 20-40 revolutions/minute, and the mixture thus formed was discharged once a temperature of 100-110° C. had been reached.

Table I shows the compositions in phr of the compounds of the examples.

TABLE I

| | Tread compound of | Tread compound of |
|---|---|---|
| | pneumatic tires | pneumatic tires |
| | A and C | B and D |
| S-SBR | — | 50 |
| NR | 60 | 50 |
| BR | 40 | — |
| Carbon black | 50 | 15 |
| Silica | — | 35 |
| ZnO | 2 | 2 |
| Stearic acid | 3.5 | 3.5 |
| Sulfur | 0.95 | 0.95 |
| Accelerant | 1.05 | 2.25 |

S-SBR is a polymer base obtained by means of a solution polymerization process with an average molecular weight respectively of between 500×10³ and 1500×10³, with a stirene content of between 20 and 45%.

NR is a 1,4-cis-polyisoprene rubber of natural origin.

BR is a butadiene rubber with a 1,4-cis content of at least 40%.

The carbon black used is the N134 type.

The silica used is marketed under the name VN3 by the company EVONIK and has a surface area of about 170 m²/g.

The vulcanization accelerant used is cyclohexyl-benzothiazyl-sulfenamide (CBS).

The different quantity of accelerant used in the various compounds derives from the different quantity of silica used. As is known to a person skilled in the art, the presence of silica modifies the rheological characteristics of the resulting compound, thus requiring the quantity of silica used to be adapted accordingly.

The treads of the four respective TBR pneumatic tires A-D were manufactured using the compounds listed above. As mentioned above, the tread of the pneumatic tires A and B have a design with slip characteristics that are greater than those of the present invention, while the treads of the pneumatic tires C and D have a design with slip characteristics according to the present invention.

The pneumatic tires A-D were subjected to a series of tests in order to evaluate the properties relating to the rolling resistance, the wet grip and the wear resistance.

The wear resistance was measured in accordance with the ISO 4649 standard and was further confirmed by means of the direct comparison of some standard pneumatic tires against some pneumatic tires according to the invention by means of Field testing, using a truck, nominally loaded and running for 24 hours a day over a fixed route, representative of the application of the pneumatic tire itself.

The rolling resistance and wet grip were measured according to both the ISO 4664 standard and the ECE R117.02 standard. In particular, as is known to a person skilled in the art, these parameters are evaluated as a function of the relative values of tan δ.

Furthermore, a “pneumatic tire durability” test was performed wherein the evaluation thereof was exclusively visual. The test provided for the counting of the number of cracks and/or damages due to the loss of compound on the tread itself after the pneumatic tire wear test on the road.

Table II lists the results obtained from the above tests. The results are expressed in indexed form on the basis of the results obtained from the pneumatic tire A which represents a TBR pneumatic tire commonly used today.

TABLE II

| | A | B | C | D |
|---|---|---|---|---|
| Wet grip | 100 | 110 | 85 | 115 |
| Rolling resistance | 100 | 110 | 103 | 113 |
| Wear resistance | 100 | 90 | 115 | 110 |
| Pneumatic tire durability | 100 | <100 | >100 | 100 |

As would appear to be evident from the data reported in Table II, the pneumatic tire according to the present invention (D) is able to guarantee, compared to the current technology, improvements in terms of rolling resistance without, for this reason, adversely affecting the wear resistance and durability of the pneumatic tire.

It should be highlighted how only the design according to the invention (pneumatic tire C) or only the compound according to the invention (pneumatic tire B) are unable to guarantee the advantages in terms of rolling resistance, wear resistance and the durability of the pneumatic tire that were sought.

In particular, the synergistic effect should be highlighted between the tread design and the composition of the compound in terms of rolling resistance and wet grip. In fact, the rolling resistance and wet grip values in relation to the pneumatic tire D are greater those relating to both the comparison pneumatic tire C (the only design according to the invention) and those in relation to the comparison pneumatic tire B (the only compound according to the invention).

1-6. (canceled)

7. A truck and bus pneumatic tire comprising:
a tread having a design with tread points, the tread having an average tread slip of less than 0.5 mm;
the tread points of the tread having a slip range of between 0.07 mm and 1.17 mm; and
wherein the tread is manufactured with a compound comprising a cross-linking unsaturated chain polymer base with from 40 to 80% by weight of a styrene-butadiene rubber (SBR), a filler comprising from 40 to 80% by weight of silica, and a vulcanization system.

8. The truck and bus pneumatic tire of claim 7, wherein the average tread slip and slip range are measured under the condition of a rolling speed of 0.012 Km/h, of a vertical load equal to the nominal load of the pneumatic tire, of torque in Nm equal to half of the nominal load of the pneumatic tire, and of lateral slip angles and camber angles equal to zero.

9. The truck and bus pneumatic tire of claim 7, wherein the cross-linking unsaturated chain polymer base comprises from 50 to 70% by weight of a stirene-butadiene rubber (SBR).

10. The truck and bus pneumatic tire of claim 7, wherein the filler comprises from 50 to 70% by weight of silica.

11. The truck and bus pneumatic tire of claim 7, wherein the polymer base comprises natural rubber.

12. The truck and bus pneumatic tire of claim 7, wherein the filler comprises carbon black.

13. The truck and bus pneumatic tire of claim 7, wherein the design of the tread comprises within a central portion thereof, a plurality of regular and/or irregular hexagons arranged therebetween with parallel edges and at a distance of between 1.0 mm and 2.0 mm;
the regular and/or irregular hexagons having a length of between 60 mm and 80 mm; and
a shaped groove with a thickness of between 0.4 mm and 0.7 mm transversely dividing the regular and/or irregular hexagons.

14. A truck and bus pneumatic tire comprising:
a tread having a design with tread points, the tread having an average tread slip of less than 0.5 mm, and the tread points of the tread having a slip range of between 0.07 mm and 1.17 mm;
the tread having within a central portion thereof, a plurality of regular and/or irregular hexagons arranged therebetween with parallel edges and at a distance of between 1.0 mm and 2.0 mm;
the regular and/or irregular hexagons having a length of between 60 mm and 80 mm; and
a shaped groove with a thickness of between 0.4 mm and 0.7 mm transversely dividing the regular and/or irregular hexagons;
wherein the tread is manufactured with a compound comprising a cross-linking unsaturated chain polymer base with from 40 to 80% by weight of a styrene-butadiene rubber (SBR), a filler comprising from 40 to 80% by weight of silica, and a vulcanization system.

15. A method of manufacturing a truck and bus pneumatic tire tread comprising the steps of:
a) mixing a filler comprising silica with 40 to 80% by weight to a polymer base with styrene-butadiene rubber to form a mixture;
b) adding a vulcanization system to the mixture of step a) to form a mixture of step b; and
c) forming a tread with tread points from the mixture of step b), the tread comprising within a central portion thereof, a plurality of regular and/or irregular hexagons arranged therebetween with parallel edges and at a distance of between 1.0 mm and 2.0 mm;
the regular and/or irregular hexagons having a length of between 60 mm and 80 mm; and
a shaped groove with a thickness of between 0.4 mm and 0.7 mm transversely dividing the regular and/or irregular hexagons.

16. The method of manufacturing a truck and bus pneumatic tire tread of claim 15, wherein the tread of step c) has an average tread slip of less than 0.5 mm, and the tread points of the tread have a slip range of between 0.07 mm and 1.17 mm.

17. The method of manufacturing a truck and bus pneumatic tire tread of claim 16, further comprising measuring the average tread slip and slip range under the condition of a rolling speed of 0.012 Km/h, of a vertical load equal to the nominal load of the pneumatic tire, of torque in Nm equal to half of the nominal load of the pneumatic tire, and of lateral slip angles and camber angles equal to zero.

18. The method of manufacturing a truck and bus pneumatic tire tread of claim 15 wherein the filler comprises carbon black.

19. The method of manufacturing a truck and bus pneumatic tire tread of claim 15 wherein the vulcanizing system comprises sulfur and accelerating compounds.

20. The method of manufacturing a truck and bus pneumatic tire tread of claim 15 wherein step b) further comprises adding zinc oxide.

21. The method of manufacturing a truck and bus pneumatic tire tread of claim 15, wherein the polymer base comprises a cross-linking unsaturated chain polymer base with from 50 to 70% by weight of a styrene-butadiene rubber (SBR).

22. The method of manufacturing a truck and bus pneumatic tire tread of claim 15, wherein the filler comprises from 50 to 70% by weight of silica.

23. The method of manufacturing a truck and bus pneumatic tire tread of claim 15, wherein the polymer base comprises natural rubber.
